(19) United States
(12) Patent Application Publication
(10) Pub. No.: US 2025/0269791 A1
(43) Pub. Date: Aug. 28, 2025

(54) NOISE EXPOSURE MANAGEMENT OF EMERGENCY VEHICLE SIREN

(71) Applicant: Federal Signal Corporation, Downers Grove, IL (US)

(72) Inventors: Paul M. Gergets, Saint John, IN (US); Joseph F. Bader, Monee, IL (US); Zeeshan Usmani, Bloomingdale, IL (US)

(21) Appl. No.: 19/024,249

(22) Filed: Jan. 16, 2025

Related U.S. Application Data
(60) Provisional application No. 63/556,935, filed on Feb. 23, 2024.

(51) Int. Cl. B60Q 5/00; B60Q 1/52; B60Q 9/00; G08B 3/10; G08B 21/18

(52) U.S. Cl. CPC B60Q 5/005; B60Q 1/52; B60Q 5/001; B60Q 9/00; G08B 3/10; G08B 21/182

(57) ABSTRACT

A system for noise exposure management. In one example, a system includes at least one speaker and a controller operatively coupled to the at least one speaker. The controller is configured to turn on and turn off the at least one speaker. The system is further configured to reduce a sound intensity of siren sounds generated by the at least one speaker when the at least one speaker is turned on in response to a signal received by the controller. The signal is generated in response to a cumulative sound exposure, over a period of time, that exceeds a predefined sound exposure magnitude.

### BACKGROUND

Emergency vehicular sirens are designed to warn motorists and pedestrians of the approach of an emergency vehicle and to call for the right-of-way. Vehicular emergency warning systems often include a high-power amplifier and speaker system which is primarily used for asking for the right of way by use of a distinct and recognizable signal tone. These systems can include numerous audio inputs, such as radio and microphone level audio, that can be output on the high-power amplifier and speaker. Another of these systems is to broadcast voice over the speaker to provide information and/or instruction to persons nearby.

### SUMMARY

In general terms, the present disclosure is directed to managing and reducing the noise exposure of an operator of an emergency vehicle.

In one aspect, a siren system for an emergency vehicle includes at least one speaker configured to generate siren sounds; and a controller operatively coupled to the at least one speaker. The controller is configured to turn on the at least one speaker such that the at least one speaker generates the siren sounds; turn off the at least one speaker such that the at least one speaker stops generating the siren sounds; and reduce a sound intensity of the siren sounds generated by the at least one speaker when the at least one speaker is turned on in response to a signal received by the controller. The signal is generated in response to a cumulative sound exposure, over a period of time, that exceeds a predefined sound exposure magnitude.

In another aspect, an emergency vehicle includes a cab, a sound detection device within the cab, and a siren system. The siren system includes at least one speaker configured to generate siren sounds and a controller operatively coupled to the at least one speaker and the sound detection device. The controller is configured to turn on the at least one speaker such that the at least one speaker generates the siren sounds, turn off the at least one speaker such that the at least one speaker stops generating the siren sounds, and reduce a sound intensity of the siren sounds generated by the at least one speaker when the at least one speaker is turned on in response to a signal received by the controller, wherein the signal is generated in response to a cumulative sound exposure, over a period of time, that exceeds a predefined sound exposure magnitude, wherein the sound detection device detects the cumulative sound exposure within the cab.

In a third aspect, a siren system for an emergency vehicle includes at least one speaker configured to generate siren sounds, and a controller operatively coupled to the at least one speaker. The controller is configured to turn on the at least one speaker such that the at least one speaker generates the siren sounds, to turn off the at least one speaker such that the at least one speaker stops generating the siren sounds, and to reduce a sound intensity of the siren sounds generated by the at least one speaker when the at least one speaker is turned on in response to a signal received by the controller. The signal is generated in response to a cumulative sound exposure, over a period of time, that exceeds a predefined sound exposure magnitude. The cumulative sound exposure is within a cab of the emergency vehicle. The cumulative sound exposure is determined using a clock configured to measure an amount of time the at least one speaker is turned on. The at least one speaker includes a first speaker configured to generate first siren sounds and operatively coupled to the controller via a first communications channel, and a second speaker configured to generate second siren sounds and operatively coupled to the controller via a second communications channel. To reduce the sound intensity of the siren sounds generated by the at least one speaker, the controller is configured to perform at least one of reduce, via the first communications channel, a sound intensity of the first siren sounds generated by the first speaker while the second speaker is turned on, reduce, via the second communications channel, a sound intensity of the second siren sounds generated by the second speaker while the first speaker is turned on, and reduce, via the first communications channel and the second communications channel, sound intensities of the first siren sounds and the second siren sounds generated by the first speaker and the second speaker when the first speaker and the second speaker are turned on. The siren system is configured to be installed on an exterior surface of a vehicle.

In a fourth aspect, siren system for an emergency vehicle includes: a controller; a first speaker configured to generate first siren sounds and operatively coupled to the controller via a first communications channel; and a second speaker configured to generate second siren sounds and operatively coupled to the controller via a second communications channel, the controller being configured to: turn on the first speaker such that the first speaker generates the first siren sounds; turn on the second speaker such that the second speaker generates the second siren sounds; turn off the first speaker such that the first speaker stops generating the first siren sounds; turn off the second speaker such that the second speaker stops generating the second siren sounds; and reduce a sound intensity of at least one of the first siren sounds and the second siren sounds generated by one or both of the first speaker and the second speaker when at least one of the first speaker and the second speaker is turned on in response to a signal received by the controller, wherein the signal is generated in response to a cumulative sound exposure, over a period of time, that exceeds a predefined sound exposure magnitude; wherein the cumulative sound exposure is within a cab of the emergency vehicle; wherein the cumulative sound exposure is determined using a clock configured to measure an amount of time one or both of the first speaker and the second speaker is turned on; and wherein to reduce the sound intensity of at least one of the first siren sounds and the second siren sounds includes to, at least one of: (i) reduce, via the first communications channel, a first sound intensity of the first siren sounds generated by the first speaker while the second speaker is turned on; (ii) reduce, via the second communications channel, a second sound intensity of the second siren sounds generated by the second speaker while the first speaker is turned on; and (iii) reduce, via the first communications channel and the second communications channel, sound intensities of the first siren sounds and the second siren sounds generated by the first speaker and the second speaker when the first speaker and the second speaker are turned on.

### BRIEF DESCRIPTION OF THE DRAWINGS

Non-limiting and non-exhaustive examples are described with reference to the following figures.

FIG. 1 illustrates an example emergency vehicle with a siren system that is configured to manage noise exposure.

FIG. 2 illustrates an example speaker system of the siren system of FIG. 1.

FIG. 3 illustrates example components of the controller of the siren system of FIG. 1.

FIG. 4 illustrates an additional example of a siren system including a dosimeter configured to manage noise exposure.

FIG. 5 illustrates a further example siren system for an emergency vehicle, the siren system being configured to manage noise exposure.

### DETAILED DESCRIPTION

Various embodiments will be described in detail with reference to the drawings. Reference to various embodiments does not limit the scope of the claims attached hereto. Additionally, any examples set forth in this specification are not intended to be limiting and merely set forth some of the many possible embodiments for the appended claims.

As briefly described above, embodiments of the present disclosure are directed to a noise exposure management system for a vehicle, such as an emergency vehicle or any other vehicle that generates siren alerts. Examples of such vehicles include, but are not limited to, ambulances, police vehicles, fire engines, official vehicles, and the like.

Possible solutions to noise exposure by occupants riding in an emergency vehicle include the occupants' wearing headphones to reduce noise. However, headphones reduce the occupants' ability to hear ambient sound which include important information, such as information that may be relayed through a radio, occupants talking to one another, or vehicles and other sources of sound outside the vehicle.

Aspects of the present siren system reduce excessive noise exposure without limiting the hearing abilities of vehicle occupants.

Part of the effectiveness of the vehicle siren is generating a recognizable tone at a certain sound pressure level (SPL). The higher the SPL level of the siren, the better the chance of the emergency vehicle to be heard and recognized by other motorists/pedestrians. Increased SPL levels also further the distance from which emergency vehicles are detected by others. There are minimum SPL requirements for sirens to be considered effective and warn nearby motorists and/or pedestrians, but these minimums are not loud enough to warn for all situations. Additionally, there is concern that making sirens too loud can put emergency vehicle operators and others at risk of exceeding noise exposure levels and increasing the risk of temporary or permanent hearing loss.

In order to provide more effective warning, vehicular sirens are generally designed to output SPL levels much higher than the minimums required for effective warning based on applicable legal standards. A drawback of this approach is the risk that emergency vehicle operators are exposed to excessive noise over the course of their workday. For example, emergency workers may work a shift that lasts 8-24 hours (or outside of this range), during which the worker is exposed to the sound of the siren for prolonged periods of time.

A vehicular siren system typically includes a power amplifier with one or more channels. These power amplifier channels connect to one or more speakers. Typically, the output of the siren's power amplifier is fixed to provide the minimum required sound pressure level (SPL) with a single amplifier output channel and a single speaker. In some examples, when multiple speakers are connected to a siren system, the SPL typically exceeds the minimum legal requirement of SPL. As the SPL increases with the number of speakers for a given siren system, occupants of an emergency vehicle are more likely to be exposed to a cumulative sound exposure that exceeds safe levels.

Cumulative sound exposure refers to a measurement of the acoustic energy of a sound over the duration of a noise event (or events). In other words, the cumulative sound exposure measures energy of sound that takes into account both the received level of sound (SPL) and duration of the exposure. By having a vehicular siren that can monitor the SPL exposure, the system can automatically reduce the overall SPL to safer levels.

For example, the siren system may include a feature for measuring its output power and keeping track of time. In one embodiment, the siren system includes a real time clock function that tracks the overall time the siren is running at a certain power level. The SPL level can be measured by a sound detection device at certain power amplifier output levels. In other examples, the cumulative sound exposure in the cab from the siren can be calculated based on the known output sound level of the connected speakers instead of using measured SPL levels. That is, cumulative sound exposure is measured based on known output sound level of a siren system multiplied by the period of time that the siren is on.

Based on the measured SPL levels or otherwise known or estimated SPL levels, a cumulative sound exposure of the occupants in the cab can be estimated. As the time of exposure to the sound increases, the cumulative sound exposure increases.

Using both the measured SPL levels and the time spent at those levels, the system can reduce the total SPL output of the system by lowering the sound levels of the connected speakers once the cumulative sound exposure reaches a predefined sound exposure magnitude. The predefined sound exposure magnitude is a maximum acceptable level of a cumulative sound exposure. This maximum may vary depending on local factors such as local guidance or regulations.

The predefined sound exposure maximum may reflect an assumption that a vehicle occupant will, or will likely, continue to be exposed to noise from the vehicle's siren system after the sound pressure adjustment has been made. Thus, for example, the trigger point at which the sound pressure level experienced inside the vehicle is automatically stepped down may be programmed to occur before a maximum daily noise exposure has been reached, e.g., at a predefined threshold noise exposure, such as a threshold within a threshold range between about 50 percent and about 100 percent, inclusive, of the maximum noise exposure permitted by at least one standard (e.g., legal standard, regulatory standard).

In some examples, the siren system is configurated to automatically cause multiple interior sound pressure level reductions at different levels of noise exposure. For example, a first step down in sound pressure level occurs when the exposure reaches 80% of a predefined exposure limit, and a second step down in sound pressure level occurs when the exposure reaches 90% of the predefined limit, with the sound pressure level within the vehicle caused by the siren system being less following the second step down than following the first step down.

In another embodiment, the system includes one or more microphones to keep track of real time SPL levels. By placing one or more microphones inside the vehicle cab, for example, a connected controller of the siren system can estimate SPL levels directly and in real time keep track of overall noise exposure during a period of time, which may be daily, a four hour shift, an eight hour shift, or some other amount of time.

Tracking overall noise exposure allows for the removal of variables that change noise penetration into the vehicle cab (e.g. different vehicle soundproofing abilities, speaker location installation, window openings, etc.). For example, an ambulance and a firetruck may have different detected SPL levels within the cab on account of the different shapes, sizes and materials of the vehicles, and the different positioning of the sirens relative to the location(s) of vehicle occupant(s). The present siren system is configured to be used on different vehicle types with different interior acoustic configurations, since the system focuses on reducing output of the speakers as opposed to blocking the sound from entering the cab. By keeping track of the overall noise level inside the cab of the vehicle, the vehicular siren can reduce the SPL levels to safer daily, or otherwise delimited, exposure limits.

The noise exposure management system may be configured in different ways to reduce the output to the minimum required output. For example, a vehicular siren system that has two speaker channels and two speakers can turn off the second speaker if the estimated daily noise exposure has reached a certain threshold. Another method to reduce the SPL is to lower the output power of the amplifier across one or more channels.

Other methods are also possible. For example, the system can be configured to allow the speakers to emit sound at higher SPLs than a minimum amount for only a set period of time. A clock can be used to track the period of time the SPL of the speaker is above the minimum required amount. Once this threshold is reached, a timer is set such the system must reduce the SPL of the speaker to the minimum amount and wait a required period of time before allowing the SPL of the speaker to rise above the minimum amount. After the required period of time passes, the timer can reset, and the emitted SPL of the speaker can be increased again. In another example, if a vehicle operator shift ends a different occupant enters the vehicle, the timer automatically resets or the new occupant can manually reset the timer via an interface of the siren system.

Typically, after being exposed to a predefined sound exposure magnitude, emergency workers need a rest period of time before being exposed to large SPL again. The required time may be eight hours, twenty-four hours, or a different amount of time. These rest periods are often described in procedures for emergency workers and best practice journals, while also being legally mandated in some cases. Controlling the amount of time the SPL is above a required minimum amount allows the siren system to optimize warning to other motorists/pedestrians and exposure of the vehicle operator(s) to excessive noise, e.g., by maximizing warning to other motorists/pedestrians while minimizing noise exposure of the vehicle operator(s). The reset time and SPL level could be programmable to comply with local regulations. The siren system can also include feedback to the vehicle operator so they can know when their siren system has lowered its output to limit their noise exposure.

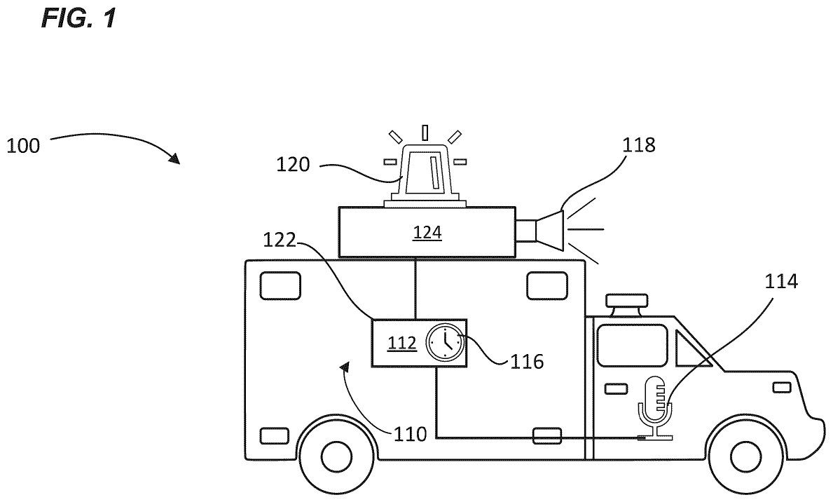

FIG. 1 illustrates an example emergency vehicle with a siren system that is configured to manage noise exposure. In the shown embodiment, a vehicle 100 includes a siren system 110 that includes a speaker system 124 and a controller 112. The controller 112 is within a housing 122 that further houses a clock 116 operatively connected to the controller 112. The speaker system 124 includes at least one speaker 118 and a light emitter 120. The controller 112 further connects and operates a sound detection device 114.

In the shown embodiment, the sound detection device 114 is configured to detect the sound exposure of the sound emitted from the speaker 118 within the cab of vehicle 100. Once the cumulative sound exposure exceeds a predefined sound exposure magnitude, the controller 112 will cause the speaker 118 to emit a lower SPL. The controller 112 is configured to turn on the at least one speaker such that the at least one speaker 118 generates the siren sounds and turn off the at least one speaker such that the at least one speaker 118 stops generating the siren sounds. In some embodiments, the cumulative sound exposure exceeds the predefined sound exposure magnitude when the at least one speaker 118 emits sound for longer than a predetermined amount of time or threshold. The clock 116 may be used to measure the predetermined amount of time. Further, the controller 112 may be configured to detect an on-state of the at least one speaker, and then begin measuring the cumulative sound exposure responsive to the detection. In some embodiments, the cumulative sound exposure exceeds the predefined sound exposure magnitude when the controller 112 calculates the cumulative sound exposure based on a SPL detected by the sound detection device 114.

Once the cumulative sound exposure is determined to have exceeded the predefined sound exposure magnitude, the controller 112 may reduce the sound levels of the siren sounds generated by the speaker 118. In some embodiments, the siren system 110 does not include the sound detection device 114. The controller measures the amount of time the speaker 118 is turned on using the clock 116. Once the speaker 118 has been turned on for a predetermined amount of time, the controller 112 lowers the speaker 118 to the required minimum.

In some embodiments, reducing the sound intensity may include lowering the SPL to the legally required minimum. In some embodiments, the at least one speaker 118 may include additional speakers not shown (e.g., 2, 3, 4 or more speakers). Reducing the sound intensity may include turning off one of the at least one speaker 118. In some embodiments, the housing 122 includes input controls, such as buttons and switches, to turn off and on the light emitter 120 and control the SPL of the at least one speaker 118.

The vehicle 100 is an emergency response vehicle in the shown embodiment. While shown as a standard ambulance, the vehicle 100 can also be a standard firetruck, police car, or other emergency/rescue vehicle in other embodiments. Further, the controller 112 and clock 116 may be embedded somewhere else rather than within the cab of the vehicle 100. For example, the housing 122 including the controller 112 and the clock 116, may be located in a trunk or within the speaker system 124.

In some embodiments, the sound detection device 114 is a dosimeter that detects SPL. Dosimeters are personal devices that measure personal noise exposure over time. They are usually small and can be easily attached through means such as a clip to a user. A dosimeter allows for easy monitoring of personal noise exposure and can be easily placed within the cab or clipped to an occupant. The dosimeter can send its detected SPL to the connected controller 112. In other embodiments, the sound detection device 114 is a microphone. The microphone can be installed anywhere in the cab of the vehicle 100, then connected back to the controller 112. The controller 112 is configured to handle any SPL calculations based on the detected audio from the microphone.

Other embodiments may use other sound detection devices. Further, vehicle 100 may include a display that connects to the siren system 110 and takes inputs to program the controller 510 and displays outputs such as statuses of siren system 110. In some embodiments, the light emitter is a light bar that also displays emergency lights.

In some embodiments, the siren system can reduce noise exposure in a variety of different ways. In some examples, the controller 112 reduces the emitted SPL of the at least one speaker 118 to a required minimum level. The required minimum may be legally required or described as best practices as the minimum SPL of a speaker to alert nearby motorists and pedestrians. In some examples, the required minimum is programmed by the user.

In some examples, the at least one speaker 118 includes an additional speaker that emits a SPL. The controller 112 may reduce the output of the at least one speaker 118 and additional speaker to a required minimum SPL.

In other examples, one of these speakers has their emitted SPL reduced. In other examples, at least one speaker 118 is oriented in a direction that results in the at least one speaker 118 contributing more to the SPL within the cab than the additional speaker. The at least one speaker 118's emitted SPL is reduced while the additional speaker's emitted SPL is increased by some magnitude (e.g., the same magnitude as the reduction), which still results in a lower cab SPL, but maintains the SPL outside of the cab so nearby motorists can hear. In some examples, the controller determines if the at least one speaker 118 is turned on. Using the clock 116, the controller determines when the at least one speaker 118 has been turned on for a predetermined amount of time. After the at least one speaker 118 has been turned on for the predetermined amount of time, the controller reduces the SPL emitted by the at least one speaker 118 to the required minimum. In some embodiments, the siren system does not include the light emitter 120.

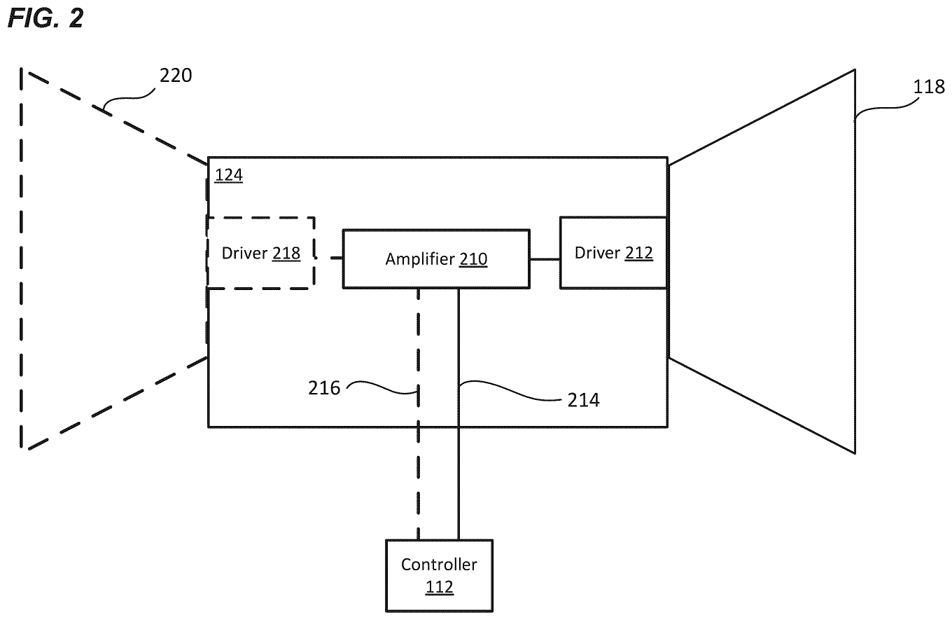

FIG. 2 illustrates an example speaker system of the siren system 110 of FIG. 1. In the shown embodiment, the speaker system 124 includes an amplifier 210 that outputs an amplified signal to a driver 212 that produces the sound for the speaker 118. Further, the controller 112 connects to the amplifier 210 through a communication channel 214. Using the communication channel 214, the controller 112 transmits signals to the amplifier 210. The amplifier 210 then provides an amplified signal to the driver 212. In some embodiments, the controller 112 connects to the amplifier 210 through a second communication channel 216 for providing an amplified signal to a second driver 218 that produces sound for an additional speaker 220 (further additional speakers and corresponding communication channels are possible).

Here, the amplifier 210 receives signals via communication channels, such as communication channels 214 and 216 that then provides amplified signals to corresponding drivers. The amplifier 210 may include a number of transistors and other electrical components to amplify received signals that will be produced to the drivers. Also, the amplifier 210 may include a power supply connection to a battery or the power source of the attached vehicle such as the vehicle 100. In some embodiments, the drivers 212 and 218 are electro-mechanical drivers that include a rotor and stator that produce the sound waves. In some embodiments, the drivers 212 and 218 are piezoelectric drivers. In other embodiments, the drivers 212 and 218 are different types of sound producing drivers. Additionally, the speaker system 124 may include one or more additional speakers such as the speaker 220.

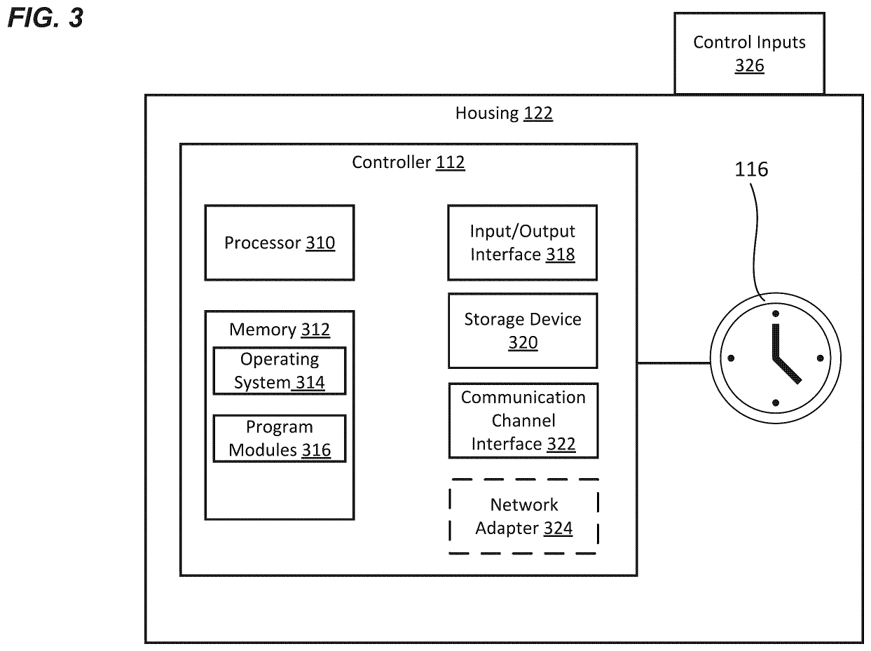

FIG. 3 illustrates example components of the controller 112 of the siren system 110 of FIG. 1. As seen in the shown embodiment, the controller 112 includes a processor 310 connected to a memory 312. The memory 312 includes operating system 314 and program modules 316. Further, the controller 112 includes an input/output interface 318, a storage device 320, and a communication channel interface 322. The controller 112 connects to the clock 116 and both are within the housing 122. Housing 122 also includes control inputs 326. In some embodiments, the controller also includes a network adapter 324.

In the shown embodiment, the processor 310 is coupled to a memory 312 through a bus or chipset that allows for data transfer. The memory 312 includes the operating system 314 that provides the functionality for the controller 112 and its components. Further, the memory 312 holds instructions and data used by the processor 310. In some embodiments, these instructions and data are stored in program modules such as program modules 316. In some embodiments, the program modules 316 include a noise exposure management module that controls outputted signals to the light emitter 120 according to the noise reduction methods and factors described herein.

The controller further includes an input/output interface 318 for connecting to switches, buttons, and other input types for programming the controller to operate as desired.

The input/output interface 318 includes one or more connection ports for communicatively connecting to other devices. Other ports may be included as well to connect to other devices. Further, the input/output interface 318 includes a power supply interface for receiving electrical current to power the shown components. Alternatively, an internal battery may be included. The included storage device 320 is any non-transitory computer-readable medium, such as a hard drive, compact disk read-only memory, or a solid-state memory device for storing other data.

In some embodiments, the clock 116 sends a clock signal to the controller 112 for the controller to calculate any predefined period or duration of time as described herein. For example, the controller 112 can receive the clock signal from the clock 116 and calculate a cumulative sound exposure based on received signals from a microphone. The received signals from the microphone are used to calculate a SPL. In combination with the clock signal, the controller is configured to determine the cumulative sound exposure based on the clock signal, which indicates an amount of time, and the microphone signal, which is used to calculate the SPL of the surrounding area of the microphone.

In addition, the controller 112 includes a communication channel interface 322. The communication channel interface includes ports for connecting to one or more communication channels that connect to the amplifier 210 and control the amplifier 210 to output a corresponding amplified signal. The amplified signal causes the driver 212 to output a sound with intensity or amplitude that corresponds to the amplified signal. In some examples, the controller 112 includes a network interface for communicating with remote devices over a wired or wireless connection. In some embodiments, the controller 112 also includes an internal clock (such as one of the clocks described herein) for measuring the period of time of the cumulative sound exposure. In some embodiments, the control inputs include buttons, switches, and other inputs to control connected light emitters, speaker systems, and other types of controls. In some embodiments, the control inputs 326 connect to the input/output interface 318 to program the controller 112. The control inputs 326 can be used to program the currently emitted SPL, minimum SPL, timers for how long the speakers can emit SPL above a minimum, timers before the SPL can be emitted above the minimum after a cumulative sound exposure reaches a predefined sound exposure magnitude, how long the speaker has been turned on, or other operations of the controller 112 of the siren system 110.

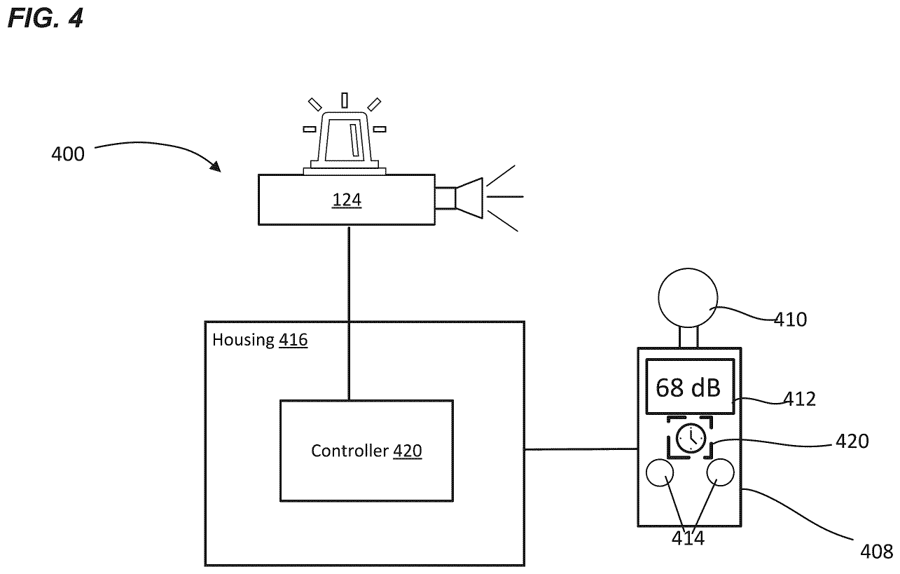

FIG. 4 depicts an additional example of a siren system including a dosimeter configured to manage noise exposure. The shown embodiment includes a siren system 400. The siren system 400 includes a dosimeter 408. The dosimeter 408 includes a microphone 410 for sound detection. Further, the dosimeter displays on a display 412 a sound pressure level measured in decibels (dB). The dosimeter 408 also includes inputs 414 for operating the dosimeter 408. Further, the siren system 400 includes housing 416 with controller 418 housed within. The controller 418 connects to speaker system 124. In some embodiments, the dosimeter 408 includes an internal clock 420 for calculating the cumulative sound exposure.

In the shown embodiment, the dosimeter 408 is used to determine the cumulative sound exposure and SPL of the surrounding environment of the dosimeter. The dosimeter 408 may be placed within the cab of an emergency vehicle and detects the SPL for determining the cumulative sound exposure in some embodiments.

In some embodiments, the dosimeter 408 is configured to connect to the controller 420 over a wired connection or a wireless connection. Using this connection, the dosimeter 408 can provide detected sound levels to the controller 112 for noise exposure management. For example, if the dosimeter detects an SPL that causes the cumulative sound exposure to exceed the predefined sound exposure magnitude, then the controller 112 will lower the sound levels emitted by the speaker 118. In some embodiments, the controller 418 does not connect to a clock within housing 416 since the dosimeter calculates the cumulative sound exposure. After calculation, the dosimeter sends the calculated cumulative sound exposure to the controller 418 that then operates speaker system 124 as previously described. In some embodiments, the controller 420 connects to an additional clock within housing 416, but not shown. The controller 420 uses this clock to measure time for programmed timers, such as a required amount of time before the SPL of speakers of speaker system 124 can increase above the required minimum.

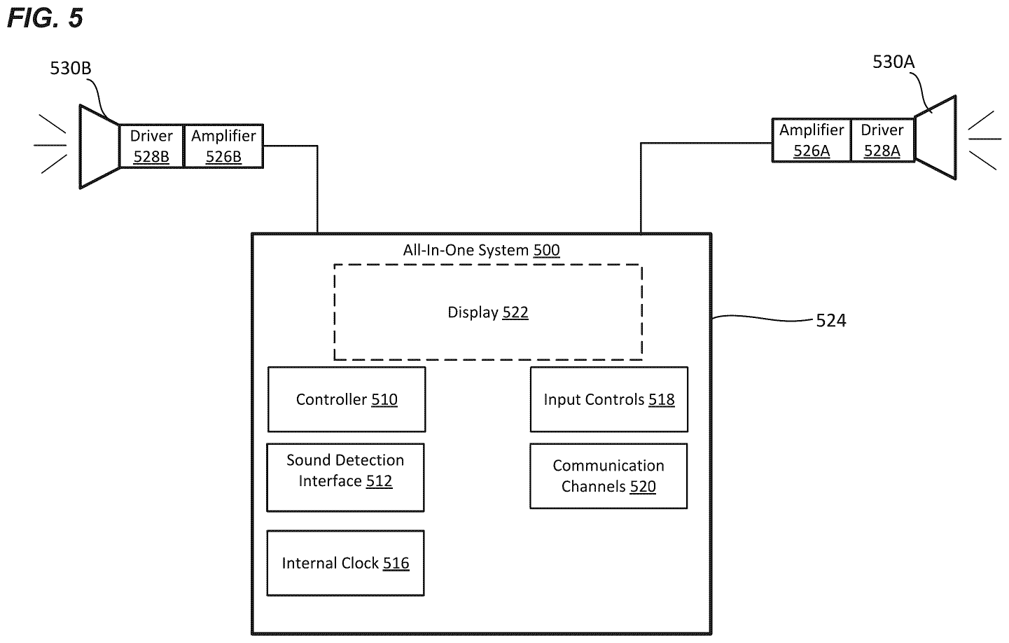

FIG. 5 illustrates a further example siren system for an emergency vehicle, the siren system being configured to manage noise exposure. The current embodiment shows an all-in-one system 500 for mounting within an emergency vehicle to enable noise exposure management. The all-in-one system includes a controller 510, a sound detection interface 512, an internal clock 516, input controls 518, communication channels 520, a display 522, a housing 524. In some embodiments, the all-in-one system 500 connects to an amplifier 526A, an amplifier 526B, a driver 528A, a driver 528B, a speaker 530A, and a speaker 350B.

In some embodiments, the controller 510 is configured to control other components. Further, the all-in-one system 500 includes a sound detection interface that includes ports for connecting to a sound detection device within the cab of an emergency vehicle. The sound detection device is used for measuring the SPL of an area, such as the interior of a vehicle cab.

The sound detection interface 512 connects to a microphone or dosimeter over a wired or wireless connection to detect emitted sound/audio.

An internal clock 516 connects to the controller 510 and is configured for measuring a period of time the SPL is above a predetermined threshold or that a siren system is in an on-state.

The all-in-one system 500 also includes input controls 518 for programming instructions into the all-in-one system 500. In some embodiments, the instructions include turning off one speaker of speakers 530A and 530B of the all-in-one system 500 once a cumulative noise exposure has reached a predefined sound exposure magnitude. In some embodiments, the instructions include lowering both speakers' output to a required minimum SPL. In some embodiments, the SPL is lowered by reducing the output power of the amplifier across one or more communication channels of communication channels 520. In some embodiments, the speakers 530A and 530B are permitted to emit a higher SPL than the minimum amount for a set period of time. The internal clock 516 may be used to track the set period of time that the SPL of speakers 530A and 530B are above the minimum required amount. Once the threshold amount of time (i.e., the previously mentioned period of time) is reached, a timer is set such the controller 510 reduces the SPL of the speakers 530A and 530B to the minimum amount and wait a required period of time before allowing the SPL of the speakers 530A and 530B to rise above the minimum amount. In some embodiments, the instructions include using the internal clock 516 to determine when the timer's set time has passed by the controller 510. In some embodiments, the instructions include resetting the timer after the required period of time passes, and the emitted SPL of the speakers 530A and 530B can be increased again. In some embodiments, the instructions include the timer resetting upon a new occupant entering the vehicle, and the old occupant exits. In some embodiments, the instructions include resetting the timer automatically. In some embodiments, the instructions include receiving input through input controls 518 that reset the timer. In some embodiments, the instructions are non-transitory instructions stored in a memory, such as memory 312, that causes the controller 512 to perform the stored instructions.

Further, the all-in-one system 500 includes its own communication channels 520 for connecting to a speaker system, such as speaker system 124, and controlling the output levels of connected speakers. In some embodiments, the all-in-one system 500 uses a display 522 to show current states, instructions, and other statuses of the all-in-one system 500.

The shown embodiment of the all-in-one system 500 is configured for use with any type of emergency vehicle. Although not shown, the all-in-one system 500 may include mounting fasteners that couple the housing 524 to an emergency vehicle. The housing 524 is a dedicated housing configured for containing the all-in-one system 500 and houses the controller 510, the sound detection interface 512, the internal clock 516, the input controls 518, and the communication channels 510. In some embodiments, the display 500 is placed on the outside surface of the housing 524. In some embodiments, the housing is configured to be mounted to the exterior of a vehicle. In some embodiments, the housing is configured to be mounted to the interior of a vehicle.

In some embodiments, the communication channels 520 operatively connect to the amplifiers 526A and 526B to enable the controller 510 to control the SPL of the speakers 530A and 530B. In some embodiments, the speakers 530A and 530B are connected to the all-in-one system 500 over a wired connection that extends a length from the all-in-one system 500. In some embodiments, the drivers 528A and 528B are also connected over a wired connection. In some embodiments, the drivers 528A and 528B are connected directly to the speakers 530A and 530B. In some embodiments, the drivers 528A and 528B directly connected to the speakers 530A and 530B are mounted remotely from the all-in-one system 500. In some embodiments, the drivers 528A and 528B and the amplifiers 526A and 526B are included within the housing 524. In some embodiments, the speakers 530A and the 530B are mounted on the housing 524.

The all-in-one system 500 connects to sound detection device within the cab of the emergency vehicle through the sound detection interface 512. This interface is configured for connection with any type of audio/data connection. In some embodiments, the sound detection device is included within the all-in-one system 500 and detects sound and measures the surrounding area's SPL of the all-in-one system 500. For example, once the controller 510 determines the cumulative sound exposure within the cab has exceeded the predefined sound exposure magnitude, it will cause the speaker to reduce the siren sounds of the speaker as previously described.

The optional display 522 and the input controls 518 allow a user to interface with the all-in-one system 500 to program various sound levels and conditions for reducing the sound output as previously described.

In some embodiments, the communication channels 520 also are configured for transmitting signals from the controller 510 to the amplifier 526. In some embodiments, these communication channels 520 can be used to control the level of sound that is emitted from the speakers 530A and 530B. In some embodiments, the communication channels 520 operatively connect the controller 510 to the amplifier 526A, 526B to control the amplifier 526A, 526B. Based on the received signals over the communication channels 520, the amplifier 526A, 526B outputs an amplified signal to the corresponding driver 528A, 528B. The drivers 528A and 528B cause the speakers 530A and 530B to emit sound. In some embodiments, the controller uses the communication channels 520 to cause the amplifier 526 to not output a signal for the drivers 528A and 528B. In some embodiments, the controller 510 uses communication channels 520 to cause the amplifier 526A, 526B to output an amplified signal that causes the driver to produce sound at a corresponding intensity. In another example, the communication channels output is all lowered so both speakers 530A and 530B produce sound at a lower level. In some embodiments, the communication channels 520 include one or more communication channels connected to the controller 510 and the amplifiers 526A, 526B.

Further, the controller 510 may be the same or similar to the controller 112. In some embodiments, the internal clock 516 is the same or similar to the clock 116. In some embodiments the amplifier 522 is the same or similar to the amplifier 210. In some embodiments, the drivers 528A and 528B are the same as driver 212. In some embodiments, speakers 530A and 530B are the same or similar to the speaker 118.

The present disclosure is not to be limited in terms of the particular embodiments described in this application, which are intended as illustrations of various aspects. Many modifications and variations can be made without departing from its spirit and scope. Functionally equivalent methods and systems within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only, and is not intended to be limiting.

The invention claimed is:

1. A siren system for an emergency vehicle, comprising:
at least one speaker configured to generate siren sounds; and
a controller operatively coupled to the at least one speaker, the controller being configured to:
turn on the at least one speaker such that the at least one speaker generates the siren sounds;
turn off the at least one speaker such that the at least one speaker stops generating the siren sounds; and
reduce a sound intensity of the siren sounds generated by the at least one speaker when the at least one speaker is turned on in response to a signal received by the controller, wherein the signal is generated in response to a cumulative sound exposure, over a period of time, that exceeds a predefined sound exposure magnitude.

2. The siren system of claim 1, wherein the cumulative sound exposure is within a cab of the emergency vehicle.

3. The siren system of claim 2, wherein the cumulative sound exposure is determined using at least one microphone.

4. The siren system of claim 3, wherein the at least one microphone is positioned inside the emergency vehicle.

5. The siren system of claim 1, wherein the cumulative sound exposure is determined using a dosimeter.

6. The siren system of claim 1, wherein the cumulative sound exposure is determined using a clock configured to measure an amount of time the at least one speaker is turned on.

7. The siren system of claim 1, wherein the at least one speaker includes:
a first speaker configured to generate first siren sounds and operatively coupled to the controller via a first communications channel; and
a second speaker configured to generate second siren sounds and operatively coupled to the controller via a second communications channel,
wherein to reduce the sound intensity of the siren sounds generated by the at least one speaker includes to, at least one of:
(i) reduce, via the first communications channel, a first sound intensity of the first siren sounds generated by the first speaker while the second speaker is turned on;
(ii) reduce, via the second communications channel, a second sound intensity of the second siren sounds generated by the second speaker while the first speaker is turned on; and
(iii) reduce, via the first communications channel and the second communications channel, sound intensities of the first siren sounds and the second siren sounds generated by the first speaker and the second speaker when the first speaker and the second speaker are turned on.

8. The siren system of claim 1, further including a clock configured to measure the period of time, wherein the controller uses the clock to determine that the cumulative sound exposure exceeds the predefined sound exposure magnitude.

9. The siren system of claim 8, wherein the controller is configured to:
detect an on-state of the at least one speaker; and
responsive to detection of the on-state, begin measuring the cumulative sound exposure using the clock.

10. The siren system of claim 9, wherein the at least one speaker includes an amplifier and a driver.

11. An emergency vehicle, comprising:
a cab;
a sound detection device within the cab; and
a siren system including:
at least one speaker configured to generate siren sounds; and
a controller operatively coupled to the at least one speaker and the sound detection device, the controller being configured to:
turn on the at least one speaker such that the at least one speaker generates the siren sounds;
turn off the at least one speaker such that the at least one speaker stops generating the siren sounds; and
reduce a sound intensity of the siren sounds generated by the at least one speaker when the at least one speaker is turned on in response to a signal received by the controller, wherein the signal is generated in response to a cumulative sound exposure, over a period of time, that exceeds a predefined sound exposure magnitude, wherein the sound detection device detects the cumulative sound exposure within the cab.

12. The emergency vehicle of claim 11, wherein the sound detection device includes a microphone.

13. The emergency vehicle of claim 11, wherein the sound detection device includes a dosimeter.

14. The emergency vehicle of claim 11, wherein the siren system further includes a clock.

15. The emergency vehicle of claim 14, wherein the cumulative sound exposure is determined using the clock configured to measure an amount of time the at least one speaker is turned on.

16. The emergency vehicle of claim 11, wherein the at least one speaker includes:
a first speaker configured to generate first siren sounds and operatively coupled to the controller via a first communications channel; and
a second speaker configured to generate second siren sounds and operatively coupled to the controller via a second communications channel,
wherein to reduce the sound intensity of the siren sounds generated by the at least one speaker includes to, at least one of:
(i) reduce, via the first communications channel, a first sound intensity of the first siren sounds generated by the first speaker while the second speaker is turned on;
(ii) reduce, via the second communications channel, a second sound intensity of the second siren sounds generated by the second speaker while the first speaker is turned on; and
(iii) reduce, via the first communications channel and the second communications channel, sound intensities of the first siren sounds and the second siren sounds generated by the first speaker and the second speaker when the first speaker and the second speaker are turned on.

17. The emergency vehicle of claim 11, further including a clock configured to measure the period of time, wherein the controller uses the clock to determine that the cumulative sound exposure exceeds the predefined sound exposure magnitude.

18. The emergency vehicle of claim 17, wherein the controller is configured to:
detect an on-state of the at least one speaker; and
responsive to detection of the on-state, begin measuring the cumulative sound exposure using the clock.

19. A siren system for an emergency vehicle, comprising:
a controller;
a first speaker configured to generate first siren sounds and operatively coupled to the controller via a first communications channel; and
a second speaker configured to generate second siren sounds and operatively coupled to the controller via a second communications channel, the controller being configured to:
turn on the first speaker such that the first speaker generates the first siren sounds;
turn on the second speaker such that the second speaker generates the second siren sounds;
turn off the first speaker such that the first speaker stops generating the first siren sounds;
turn off the second speaker such that the second speaker stops generating the second siren sounds; and
reduce a sound intensity of at least one of the first siren sounds and the second siren sounds generated by one or both of the first speaker and the second speaker when at least one of the first speaker and the second speaker is turned on in response to a signal received by the controller,
wherein the signal is generated in response to a cumulative sound exposure, over a period of time, that exceeds a predefined sound exposure magnitude;
wherein the cumulative sound exposure is within a cab of the emergency vehicle;
wherein the cumulative sound exposure is determined using a clock configured to measure an amount of time one or both of the first speaker and the second speaker is turned on; and
wherein to reduce the sound intensity of at least one of the first siren sounds and the second siren sounds includes to, at least one of:
(i) reduce, via the first communications channel, a first sound intensity of the first siren sounds generated by the first speaker while the second speaker is turned on;
(ii) reduce, via the second communications channel, a second sound intensity of the second siren sounds generated by the second speaker while the first speaker is turned on; and
(iii) reduce, via the first communications channel and the second communications channel, sound intensities of the first siren sounds and the second siren sounds generated by the first speaker and the second speaker when the first speaker and the second speaker are turned on.

20. The siren system of claim 19, wherein the controller calculates the cumulative sound exposure based on a measured sound pressure level within the cab.
